(19) United States
(12) Patent Application Publication
(10) Pub. No.: US 2014/0025532 A1
(43) Pub. Date: Jan. 23, 2014

(54) Correlated Content Recommendation Techniques

(71) Applicant: barnesandnoble.com llc, New York, NY (US)

(72) Inventors: Jonathan Huizhong Huang, Cupertino, CA (US); Yufan Hu, North Brunswick, NJ (US)

(21) Appl. No.: 13/944,395

(22) Filed: Jul. 17, 2013

Related U.S. Application Data
(60) Provisional application No. 61/673,595, filed on Jul. 19, 2012.
(60) Provisional application No. 61/673,593, filed on Jul. 19, 2012.

(51) Int. Cl. G06Q 30/06

(52) U.S. Cl. CPC G06Q 30/0631
USPC 705/26.7

(57) ABSTRACT

Techniques are disclosed for generating and ranking product recommendations based at least in part on product attributes. Two or more sets of product recommendations may be generated based on a source product. The recommendation sets may include products also purchased by those who purchased the source product, products within the same genre as the source product, or products with some other trait in common with the source product. The product recommendations may be initially ranked based on overlap within the recommendation sets. A product attribute relating to the source product or one or more of the product recommendations may be determined, and this attribute may be correlated with the product recommendations. The recommendations may then be re-ranked based on the correlated product attribute and a product recommendation list may be displayed to the user. The recommendation list may be limited to a particular type of product using a control filter.

### RELATED APPLICATION

This application claims the benefit of U.S. Provisional Application Nos. 61/673,595 and 61/673,593, both filed on Jul. 19, 2012. Each of these applications is herein incorporated by reference in its entirety.

### FIELD OF THE DISCLOSURE

This disclosure relates to product searches and recommendations, and more particularly, to the ranking of product recommendations.

### BACKGROUND

Online browsing and shopping techniques allow users to search products and services as well as discover other products and services similar to those searched. Recommendations may also be displayed to the user, and the recommendations may include other products or services offered by the same seller or provider or products or services related to a specific product or service. Users may also limit their search or analysis to products or services that are related to their previous purchases or searches.

### BRIEF DESCRIPTION OF THE DRAWINGS

FIG. 1 is a diagram of three sets of user recommendations, in accordance with an embodiment of the present invention.

FIG. 2a-c illustrate an example multi-level content recommendation ranking technique, in accordance with an embodiment of the present invention.

FIG. 3 illustrates an example product recommendation list that may be displayed to a user, in accordance with an embodiment of the present invention.

FIG. 4a illustrates a block diagram of an electronic touch screen device configured in accordance with an embodiment of the present invention.

FIG. 4b illustrates a block diagram of a communication system including the electronic touch screen device of FIG. 4a, configured in accordance with an embodiment of the present invention.

FIG. 4c illustrates a block diagram of a content recommendation system configured in accordance with an embodiment of the present invention.

FIG. 5 illustrates a method for providing a user with a product recommendation list, in accordance with an embodiment of the present invention.

### DETAILED DESCRIPTION

Techniques are disclosed for generating and ranking product recommendations based at least in part on product attributes. Two or more sets of product recommendations may be generated based on one or more source products or services (collectively referred to as “product” hereinafter). The recommendation sets may include products also purchased by those who purchased the source product, products within the same genre as the source product, or products with some other trait in common with the source product. These product recommendation sets may include some product overlap, and the product recommendations may be initially ranked based on the product overlap within the recommendation sets. A product attribute relating to one or more of the source products or one or more of the product recommendations may be determined, and this attribute may be correlated with the product recommendations. Correlating the attribute with the product recommendation may include, for example, determining which product recommendations have that attribute or which recommendations have a similar or related attribute. The recommendations may then be re-ranked based on the correlated product attribute and an intelligently ranked product recommendation list may be displayed to the user. The recommendation list may be limited, for example, to a particular type of product or a particular set of friends using a control filter.

General Overview

As previously explained, online searching techniques are commonly used to discover new content and display to a user a set of product recommendations, but such techniques may be limited in scope and any ranking or organization of the recommendations may need to be actively input or selected by the user. Such techniques fail to incorporate an efficiently correlated recommendation based on multiple factors, product attributes, and/or user preferences. While product recommendation techniques exist for notifying users of similar content, the product recommendation techniques described herein may provide a more efficiently ranked and correlated content recommendation list.

Thus, and in accordance with an embodiment of the present invention, in some embodiments, a ranked product recommendation list based in part on one or more correlated product attributes may be presented to the user. In one embodiment, one or more product recommendation sets may be identified based on a source product, which could be a single book the user has purchased, a product entered into a recommendation search engine, or any other content of interest to the user. The products may include a number of available items or services, such as, but not limited to books, eBooks, movies, music, electronics, clothing, magazines, etc. In some cases, multiple product recommendation sets may be determined based on products that the user has purchased or positively reviewed. In some embodiments, the product recommendation sets may include other products purchased by those who purchased the source product, other products within the same genre as the source product, or products with any other trait in common with the source product. Thus, the product recommendation

Once the product recommendation sets have been determined, they may be analyzed in order to identify one or more sets of overlapping products present in more than one product recommendation set. The product recommendations may then be placed into an initial ranking based on product overlap, wherein the products present in the largest number of product recommendation sets have the highest priority. For example, if three product recommendation sets A, B, and C have been determined based on source products a, b, and c, the overlapping products included within set A&B&C will be ranked highest; while the overlapping products included in sets A&B, A&C, and B&C will be ranked next; followed by the products included only within sets A, B, or C. In this example, set A has the highest priority followed by sets B and C, and this priority may be based on the user's ranking/reviews of the source products a, b, and c.

One or more product attributes may then be determined based on the source products and/or the product recommendation sets. Product attributes may include subject matter, author, artist, brand, genre, category, genre taxonomy, critical reviews, etc. In some embodiments, the product attributes may be received as structured or unstructured meta-data from book publishers (e.g., a 13-digit ISBN, 9-digit SBN, EAN-13 barcode), e-commerce sites, databases, or any other source containing product information or descriptions. In some embodiments, the product attribute may be an attribute of one or more of the source products. In other embodiments, the product attribute may depend on the overlapping products contained within the product sets discussed above. For example, the products with the greatest overlap between product recommendation sets (e.g., those within the overlapping product set A&B&C) may be analyzed in order to identify a common attribute, in some embodiments.

Once a product attribute has been determined, the attribute may be correlated to the products within the product recommendation sets determined above. For example, if the product attribute is the horror genre, or the author John Smith, the products within the product recommendation sets may be divided into products in the horror genre, products by John Smith, products by authors similar to John Smith, or products that do not fall into one of the three previous groups. In some embodiments, multiple product attributes may be identified and correlated. In one such example, if the user's taste profile favors a specific author more than books in a specific genre, the author attribute may have a greater priority than the genre attribute. In other embodiments, the product attribute priority may be determined based on product overlap between the product recommendation sets. Once the one or more attributes have been correlated to the product recommendations and attribute priority has been determined, the product recommendations may be ranked accordingly. In one embodiment, the initial product recommendation ranking based on product overlap may be merged with a product attribute correlation and the recommendation list may be re-ranked. The resulting recommendation list may then be presented to the user.

In some embodiments, there might be a tie between two products that fall in the same ranking group. In such an embodiment, another level of analysis may be performed and this level may be limited to the products that fall within the same ranking group. In one such example, if two books fall within the same overlapping products set and have the same product attribute, an additional product attribute may be identified, the attribute may be correlated to the product recommendations, and the two books may be re-ranked accordingly. Repeating the product attribute correlation and re-ranking the recommendations may provide an intelligent multi-level ranking technique for displaying product recommendations to a user. In some embodiments, a control filter may be applied that limits the product recommendation list based on predetermined criteria that may be set by the user. In some examples, the predetermined criteria may be a specific content format (e.g., videos, eBooks, music), a similar set of hobbies, a particular group of friends, etc. In one such example, the user is only interested in eBooks, so all non-eBook products will be filtered out of the final product recommendation list. The control filter may be applied at any point in the product recommendation method, and it does not need to be applied after the product recommendations have been correlated and ranked.

In one example embodiment, the content recommendation techniques described herein may be incorporated into the user interface of an electronic device and the recommendation list may be displayed on the device's touch screen display. Another embodiment may include a server programmed or otherwise configured to compute and provide the recommendation list as described in response to a user query. Re returned results can then be presented to the user, for example, on a display or printout. Although the example of books is used throughout this disclosure, it is appreciated that other forms of content (e.g., physical books, physical or digital magazines, videos, music, software applications, games, etc.), as well as other services may be recommended to the user with the content recommendation techniques disclosed herein.

Content Recommendation Examples

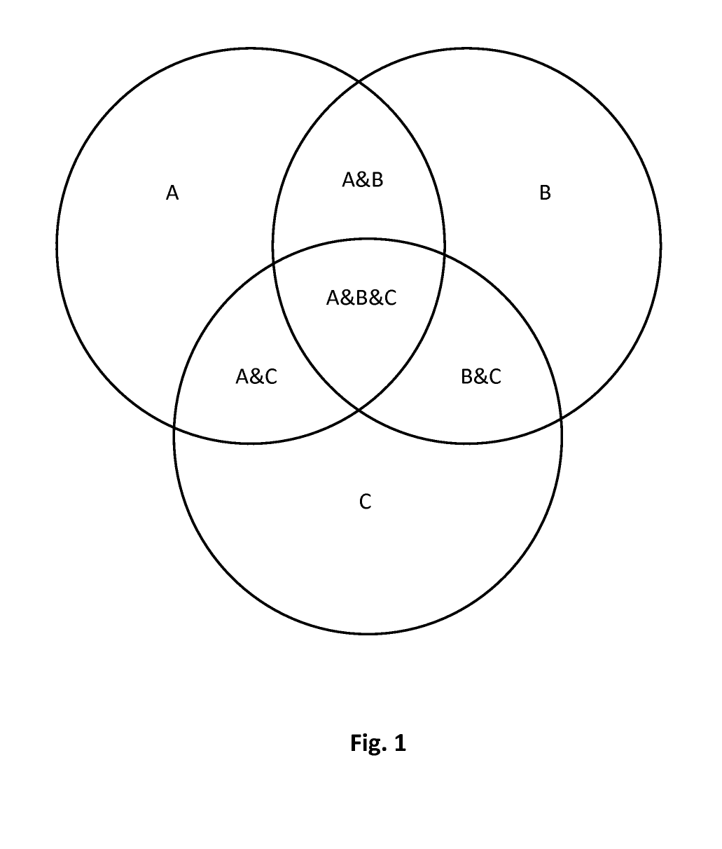

FIG. 1 is a diagram of three sets of user recommendations, in accordance with an embodiment of the present invention. The diagram includes three partially overlapping circles A, B, and C, each representing a set of products. In one embodiment, the user may have purchased books a, b, and c, which will be considered the source products for the product recommendations; and the product sets A, B, and C may include items frequently purchased by those who purchased books a, b, and c respectively. In one example, book a may be a business textbook and product set A may include books related to business management and leadership. In such an example, source products a, b, and c may be input to a single product recommendation engine resulting in three product sets. The products may include multiple available items or services, such as, but not limited to books, eBooks, movies, music, electronics, clothing, magazines, etc.

In one specific example, book a is a book by James Patterson, book b is a book by Steven King, and book c is a book by Margaret Atwood. In this example case, product set A includes books also purchased by those who purchased book a, product set B includes books also purchased by those who purchased book b, and product set C includes books also purchased by those who purchased book c; and the product sets A, B, and C each include 35 books. The diagram of the three product sets shown in FIG. 1 includes multiple intersecting areas between the circles, each area representing a set of overlapping products. For example, the area in the center of the diagram represents five books that are within the set of overlapping products A&B&C; while the other overlapping areas each represent six books included in product sets A&B, A&C, or B&C. Each product set A, B, and C also includes eighteen books not in common with the other two sets, creating a total of 77 products that may be recommended to the user.

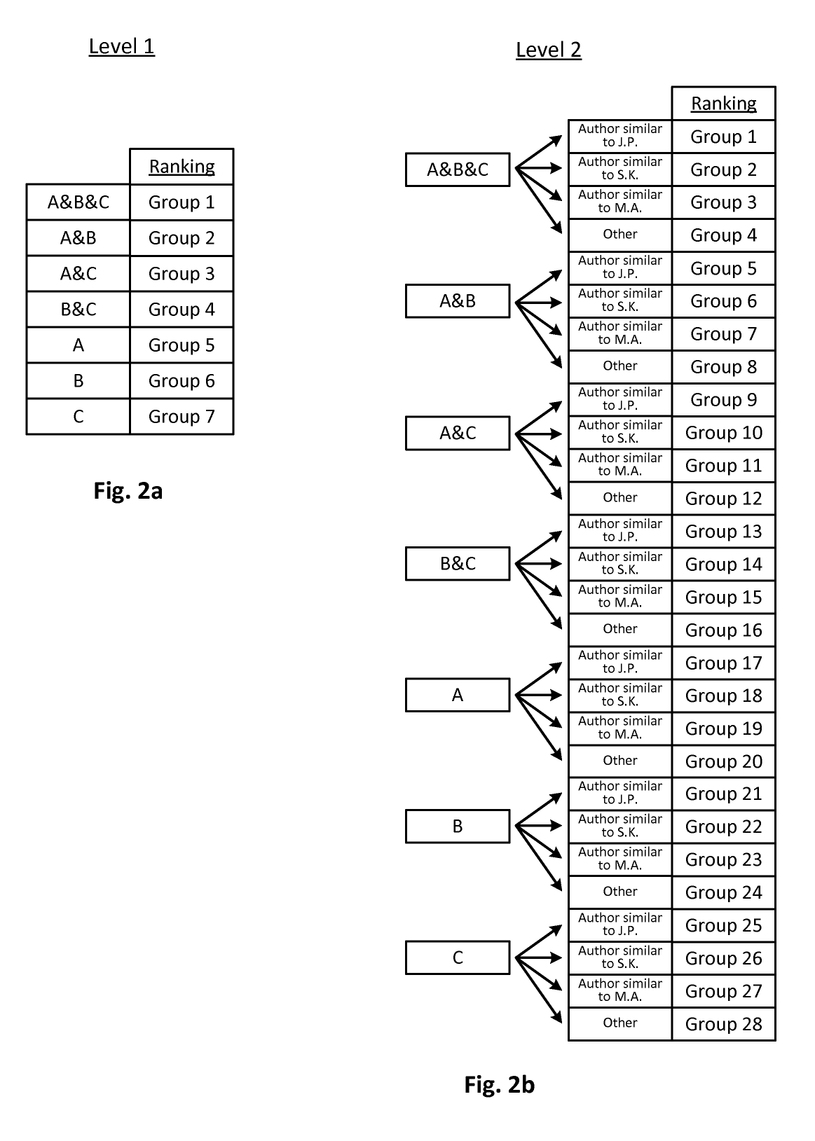

FIGS. 2a-c collectively illustrate an example multi-level content recommendation ranking technique, in accordance with an embodiment of the present invention. Generally: FIG. 2a shows a first level content recommendation ranking accounting for product overlap within multiple product sets; FIG. 2b shows a second level content recommendation ranking that has re-ranked the products based on a correlated product attribute; and FIG. 2c shows a third level content recommendation ranking that has re-ranked the products based on a second correlated product attribute.

FIG. 2a illustrates a first level product recommendation ranking, according to one embodiment of the present invention. In one embodiment, the ranking of the 77 product recommendations in the product sets shown in FIG. 1 may begin by placing each of the products into an initial seven groups based on product overlap. For example, the five products included in product set A&B&C may be placed at the top of a list in group 1 due to the most amount of product overlap. In this example embodiment, the products that overlap between only two product sets may then be ranked in groups 2-4. In one example, the ranking priority may be determined based on the user's review or rating of books a, b, and c. In one such example, the user has given a very positive review to book a, a somewhat positive review to book b, and an average review to book c; so the products in set A have greatest priority, followed by those products in sets B and C respectively. Therefore, in this example the products included in set A&B fall into group 2, those within set A&C fall into group 3, and those in set B&C fall into group 4. Likewise, the products included only in one of sets A, B, or C may be ranked into groups 5-7 as shown in FIG. 2a. As will be appreciated, the ranking priority may be based on many factors other than the user's reviews/ratings, including the user's reading history, search history, purchase history, favorite authors, favorite brands, wish list, browser behavior, similar hobbies, demographic, or other features of the user's taste profile.

FIG. 2b illustrates a second level product recommendation ranking, according to one embodiment of the present invention. This second level of analysis may include identifying attributes of the source products a, b, and c, performing product attribute correlation, and re-ranking the product recommendation list. Product attributes may include subject matter, author, artist, genre, category, genre taxonomy, critical reviews, etc. In some embodiments, the product attributes may be received as structured or unstructured meta-data from book publishers (e.g., a 13-digit ISBN, 9-digit SBN, EAN-13 barcode), e-commerce sites, databases, or any other source containing product information or descriptions. In this particular example, book a is written by James Patterson, book b is written by Steven King, and book c is written by Margaret Atwood (the authors are initialed J. P., S. K., and M. A. in FIGS. 2b-c). In one embodiment, product attribute correlation may include analyzing several books by James Patterson, identifying characteristics of the author, and correlating this information to similar authors and/or author characteristics. For example, an author may be considered a contemporary popular author, an historian, a post-modernist fiction writer, a biographer, etc., and these attributes may be correlated to other similar authors. In some embodiments, attributes such as a book's subject, author, or category may have pre-calculated correlations that may be gathered from the product's meta-data. For example, the subject “Science/Technology” may be correlated to “photography,” “engineering,” or “study aids,” while the author “James Patterson” may be correlated to “Clifton Campbell,” “Yaritza Garcia,” “Chef Dave,” or “W. D. Newman.”

In this particular example, the author attribute of each of the three source products a, b, and c is correlated to identify similar authors, and the products in level 1, group 1 (those contained in overlapping product set A&B&C) are divided into books by authors similar to James Patterson, books by authors similar to Steven King, books by authors similar to Margaret Atwood, and books that do not fall into one of the previous three groups. These four groups may then be re-ranked as groups 1-4 of level 2, and likewise the products in groups 2-7 of level 1 may be re-ranked within groups 5-28 of level 2 as shown in FIG. 2b. In one embodiment, other books by James Patterson in level 1, group 1 will be ranked higher in level 2 than books by authors similar to James Patterson, and likewise for the other authors. In this particular example, books with authors similar to James Patterson have a higher priority than those by Steven King because of the user's more positive review of book a as compared to book b. As discussed above, the ranking priority may be based on many other factors other than the user's reviews/ratings, including the user's reading history, search history, purchase history, favorite authors, favorite brands, wish list, browser behavior, or other features of the user's taste profile.

FIG. 2c illustrates a third level product recommendation ranking, according to one embodiment of the present invention. This third level of analysis may include identifying the genres of the products a, b, and c, performing product attribute correlation, and re-ranking the product recommendation list. In some embodiments, the product genres may be received as structured or unstructured meta-data from book publishers (e.g., a 13-digit ISBN, 9-digit SBN, EAN-13 barcode), e-commerce sites, databases, or any other source containing product information or descriptions. In this particular example, book a is a romance novel, book b is a thriller, and book c is poetry. In one embodiment, product attribute correlation may include analyzing the books within each of the groups 1-28 of level 2, determining which books fall within the romance, thriller, poetry, or other similar genres, and re-ranking the product recommendation list according to the newly correlated attribute. In this particular embodiment, the products in level 2, group 1 (those contained in set A&B&C and with authors similar to James Patterson) are divided into romance books, thriller books, poetry books, and books that do not fall into the previous three groups. These four groups may then be re-ranked as groups 1-4 of level 3, and likewise the products in groups 2-28 of level 2 may be re-ranked within groups 5-112 of level 3.

Because level 3 of the product recommendation ranking includes 112 groups, many groups may not include any of the 77 product recommendations included in sets A, B, and C. This may also be the case with some of the groups of level 2, while some groups in levels 2 and 3 may include more than one product. If multiple products are ranked within the same group, an additional level of product attribute correlation and re-ranking may be performed in order to determine the order in which those products will be recommended to the user. In some embodiments, each level of product attribute correlation and re-ranking may be performed only on products that are tied within the same ranking group of the previous ranking level.

Although the attributes identified in these specific examples include author and genre, many other attributes may be analyzed and correlated in order to intelligently rank and present product recommendations to a user. In some embodiments, the attribute analyzed in level 2 or 3 may depend on the overlapping products contained within the product sets A, B, and C. For example, the highest priority group within level 1 is the set of overlapping products A&B&C; therefore, the products within level 1, group 1 may be analyzed in order to identify a common attribute. In one such example, it is determined that all the products within level 1, group 1 are rated four stars or higher by critics, and therefore the products within groups 2-7 of level 1 may be analyzed and re-ranked into additional groups based on the critical ratings of those products. Such an example would result in level 2 of the product recommendation ranking having 15 groups. Additional product attributes than those identified herein may be used to correlate and rank product recommendations and the present invention is not intended to be limited to any specific set of product attributes. Also, although the examples provided herein describe three product sets A, B, and C, fewer or more product sets may be analyzed in order to create the product recommendation list. Furthermore, additional or fewer levels of product attribute correlation and re-ranking may be performed as needed in order to provide product recommendations to a user.

If the product recommendation list is sufficiently organized and ranked, and no additional re-ranking is needed, a control filter may be applied to the product recommendation list, in some embodiments. In one embodiment, the control filter limits the eventual output result by filtering product recommendations for a particular product or demographic. For example, the control filter might only list a particular product type (e.g., only eBooks), or if the product recommendations are viewable by multiple users the content filter might only display the product recommendations to a particular demographic (e.g., a particular set of friends). In other embodiments, the control filter may be applied to the product recommendations before their initial ranking and re-ranking is performed.

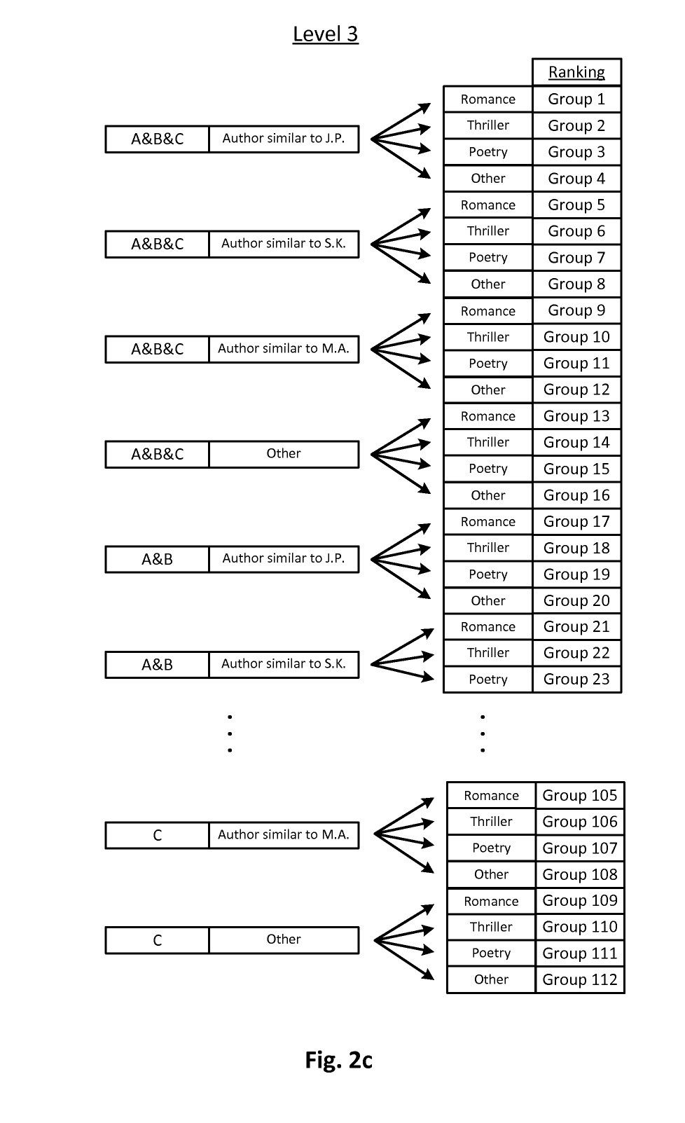

FIG. 3 illustrates an example product recommendation list that may be presented to a user, in accordance with an embodiment of the present invention. In some embodiments, the product recommendation list may be displayed to the user on the touch screen of an electronic device. In this particular example, the product recommendations are books and the list of source products is displayed to the user on the left-hand side, accompanied by the recommended products list on the right-hand side. In this embodiment, a control filter option is displayed above the product lists so the user may limit the product recommendation search to a particular type of product. In the example shown, the product recommendation list is limited to paperback products. As can be seen in this example, the books are listed with an image of the book cover as well as a list of relevant data and book attributes that show correlated product purchases, reviews, etc. Thus, the user may compare the product recommendations with the source products, in this embodiment.

Architecture

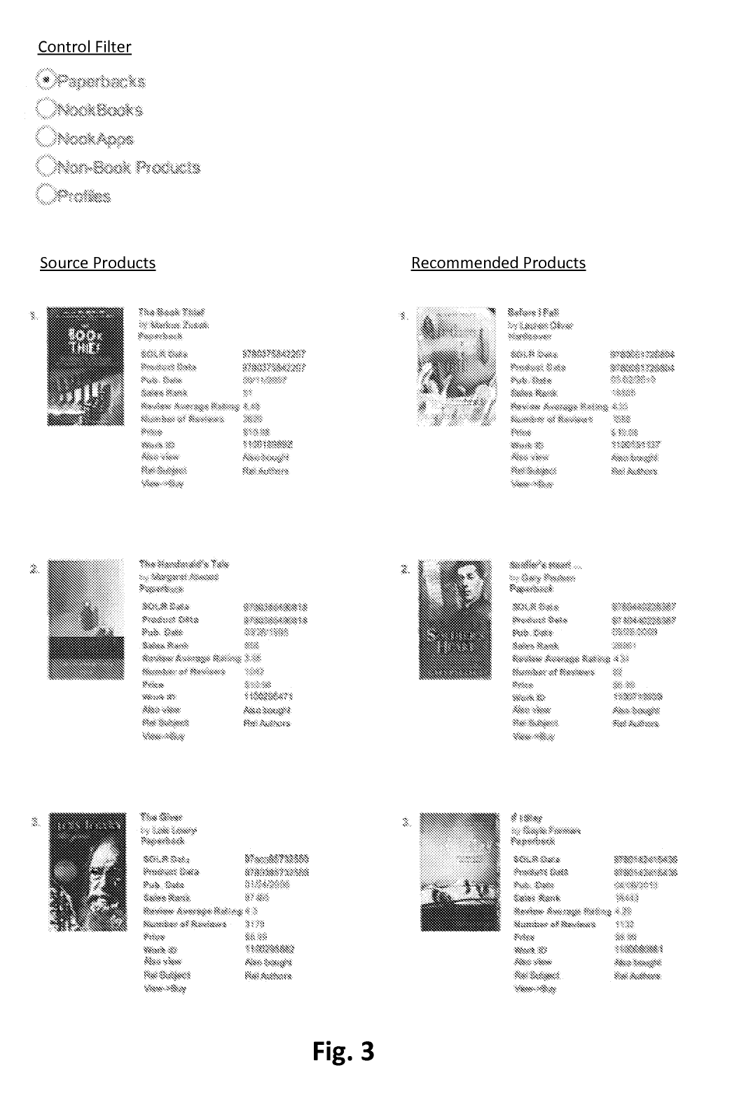

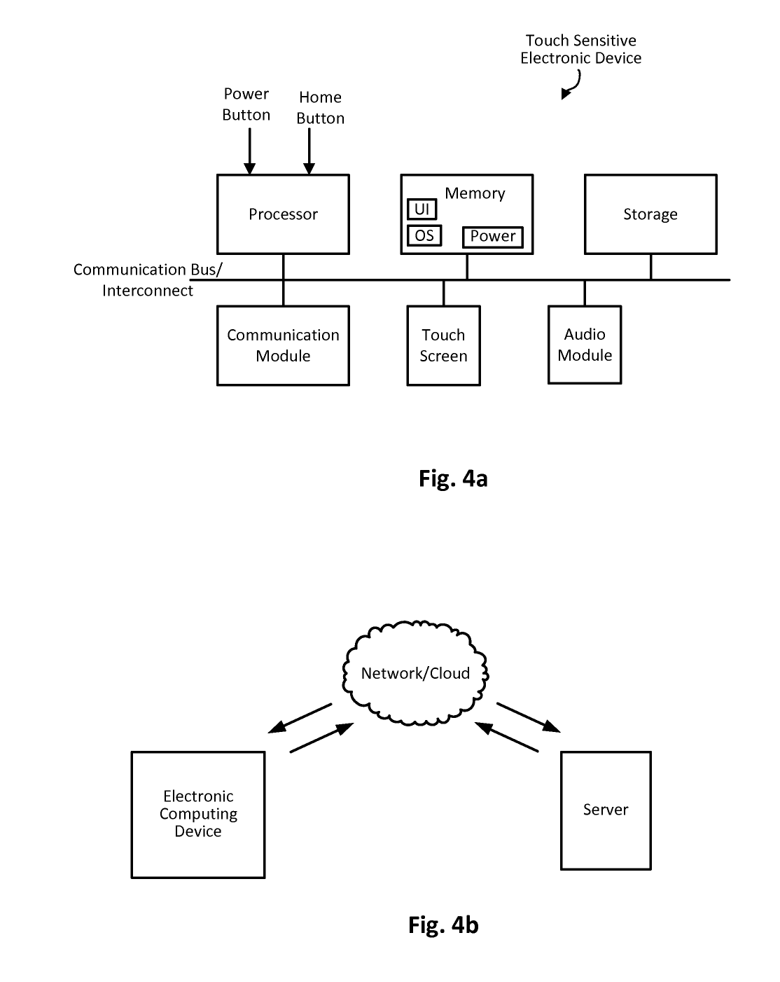

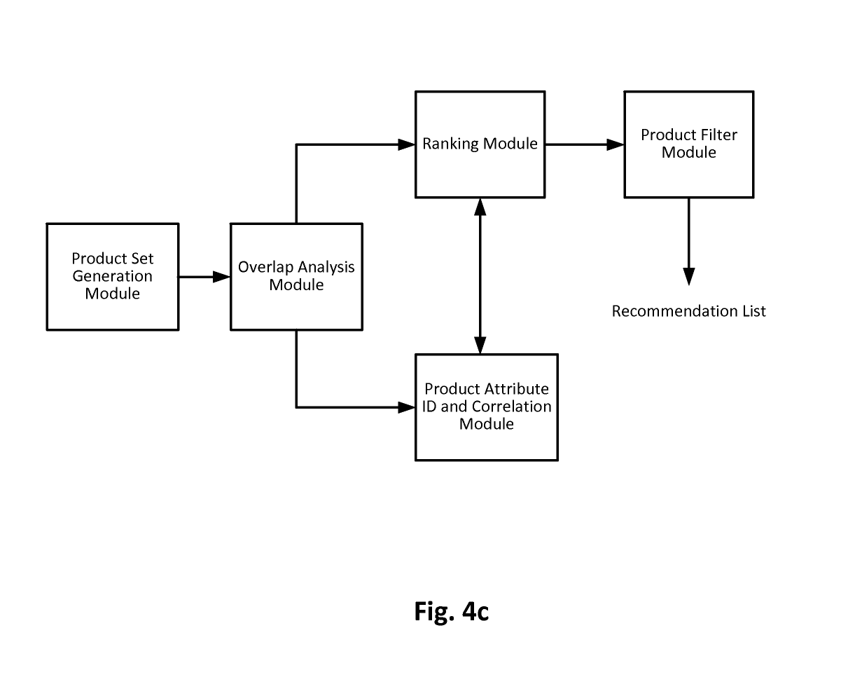

FIG. 4a illustrates a block diagram of an electronic touch screen device configured in accordance with an embodiment of the present invention. The device could be, for example, a tablet such as the NOOK® tablet or eReader by Barnes & Noble. In a more general sense, the device may be any electronic device having a touch sensitive user interface for detecting direct touch or otherwise sufficiently proximate contact, and capability for displaying content to a user, such as a mobile phone or mobile computing device such as a laptop, a desktop computing system, a television, a smart display screen, or any other device having a touch sensitive display or a non-sensitive display screen that can be used in conjunction with a touch sensitive surface. As will be appreciated in light of this disclosure, the claimed invention is not intended to be limited to any specific kind or type of electronic device or form factor.

As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc.). The touch screen and underlying circuitry is capable of translating a user's contact (direct or proximate) with the touch screen into an electronic signal that can be manipulated or otherwise used to trigger a specific user interface action, such as a content recommendation request. The principles provided herein equally apply to any such touch sensitive devices.

In this example embodiment, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc.), and encoded on a machine readable medium, that when executed by the processor (and/or co-processors), carries out the functionality of the device including a UI having a content recommendation function as variously described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose-built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., Texas Instruments OMAP4, dual-core ARM Cortex-A9, 1.5 GHz), and may include one or more co-processors or controllers to assist in device control. In this example case, the processor receives input from the user, including input from or otherwise derived from the power button and the home button. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory). The display can be implemented, for example, with a 7 to 9 inch 1920×1280 IPS LCD touchscreen touch screen, or any other suitable display and touchscreen interface technology. The communications module can be, for instance, any suitable 802.11b/g/n WLAN chip or chip set, which allows for connection to a local network, and so that content can be exchanged between the device and a remote system (e.g., content provider or repository depending on the application of the device). In some specific example embodiments, the device housing that contains all the various componentry measures about 7″ to 9″ high by about 5″ to 6″ wide by about 0.5″ thick, and weighs about 7 to 8 ounces. Any number of suitable form factors can be used, depending on the target application (e.g., laptop, desktop, mobile phone, etc.). The device may be smaller, for example, for smartphone and tablet applications and larger for smart computer monitor and laptop and desktop computer applications.

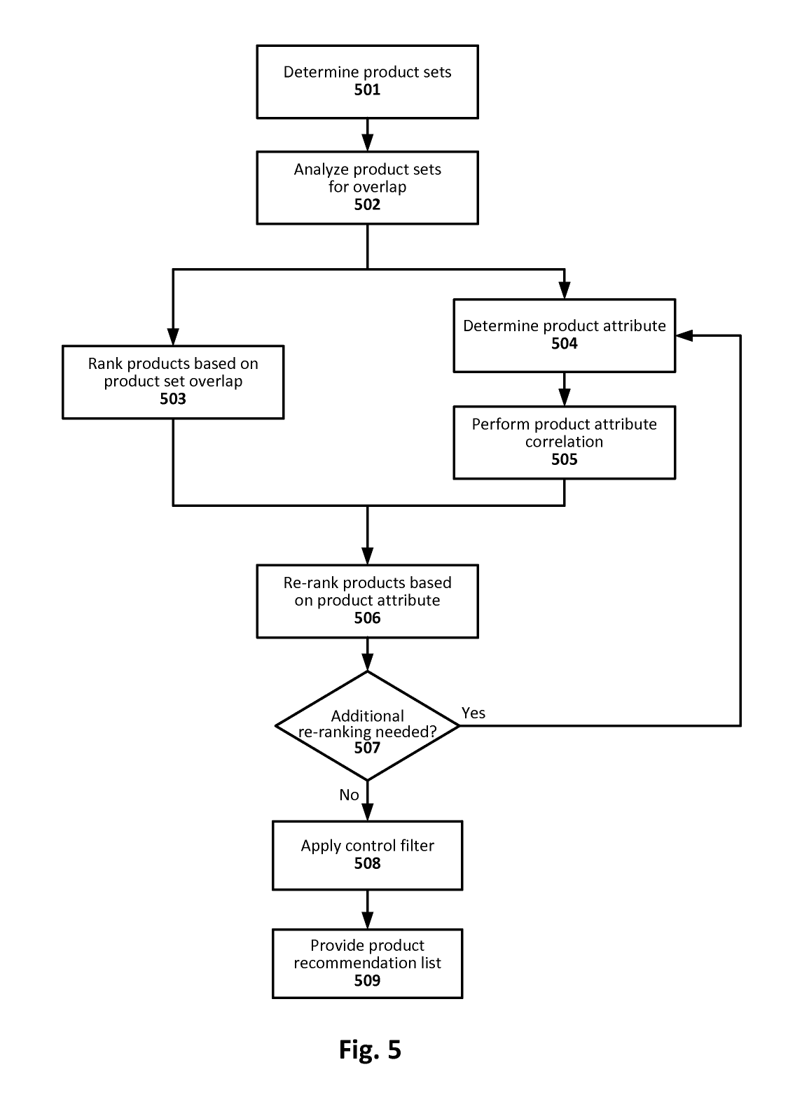

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms. The power management (Power) module can be configured as typically done, such as to automatically transition the device to a low power consumption or sleep mode after a period of non-use. A wake-up from that sleep mode can be achieved, for example, by a physical button press and/or a touch screen swipe or other action. The user interface (UI) module can be, for example, based on touchscreen technology and may include a content recommendation function in accordance with the methodologies illustrated in FIG. 5, which will be discussed in turn. The audio module can be configured to speak or otherwise aurally present, for example, a product recommendation list, or other textual content, and/or to provide verbal and/or other sound-based cues and prompts to guide the content recommendation process, as will be appreciate in light of this disclosure. Numerous commercially available text-to-speech modules can be used, such as Verbose text-to-speech software by NCH Software. In some example cases, if additional space is desired, for example, to store digital books or other content and media, storage can be expanded via a microSD card or other suitable memory expansion technology (e.g., 32 GBytes, or higher). Further note that although a touch screen display is provided, other embodiments may include a non-touch screen and a touch sensitive surface such as a track pad, or a touch sensitive housing configured with one or more acoustic sensors, etc.

Client-Server System

FIG. 4b illustrates a block diagram of a communication system configured in accordance with an embodiment of the present invention. As can be seen, the system generally includes an electronic computing device (such as the one in FIG. 4a) that is capable of communicating with a server via a network/cloud. In this example embodiment, the electronic computing device may be, for example, an eBook reader, a mobile cell phone, a laptop, a tablet, desktop, or any other suitable computing device with which a user can access the server via the network/cloud. The network/cloud may be a public and/or private network, such as a private local area network operatively coupled to a wide area network such as the Internet. In this example embodiment, the server may be programmed or otherwise configured to receive content requests from a user via the touch sensitive device and to respond to those requests by performing a desired function or providing the user with requested or otherwise recommended content. Is some such embodiments, the server is configured to remotely provision a content recommendation function as provided herein to the touch screen device (e.g., via JavaScript or other browser based technology), so that the content recommendation function can be executed locally on the computing device. Alternatively, the server can be configured to carry out the content recommendation function independent of the computing device, or in response to requests from the user device. In other embodiments, portions of the content recommendation methodology can be executed on the server and other portions of the methodology can be executed on the device. Numerous server-side/client-side execution schemes can be implemented to facilitate a content recommendation function in accordance with an embodiment, as will be apparent in light of this disclosure.

FIG. 4c illustrates a block diagram of a content recommendation system, configured in accordance with an embodiment of the present invention. As can be seen, the system includes a product set generation module, an overlap analysis module, a product attribute identification and correlation module, a ranking module, and a product filter module. As will be appreciated in light of this disclosure, the modules may be implemented, for instance, in software, firmware, hardware or any combination thereof. In addition, the functional modules may be implemented, for example, in the UI of a computing device, on a remote server, or in a distributed fashion where one or more modules are implemented on the computing device and other modules are implemented on the server. As will be further appreciated, other embodiments may be implemented with a different degree of modularity and include fewer or additional modules, as the case may be, with the overall system functionality being as variously described herein.

In some embodiments, the product set generation module may be configured to generate two or more product recommendation sets based on one or more source products. The product sets may be the sets A, B, and C shown in FIG. 1, in one example. Once the product sets have been generated, the overlap analysis module may determine the product recommendation overlap described above and also illustrated in FIG. 1. In one embodiment, the ranking module may generate an initial product recommendation ranking based on the product set overlap, while the product attribute identification and correlation module may identify a product attribute and correlate that attribute to the product recommendations included within the multiple product recommendation sets. The product attribute may be an attribute associated with one or more of the source products, in some embodiments, or it may be an attribute determined based on the product set overlap analyzed at the overlap analysis module. The product recommendations may then be re-ranked based on the correlated product attribute or attributes. In some embodiments, if additional re-ranking is needed another product attribute may be identified and correlated to the product recommendations and the product recommendations may be re-ranked based on the newly correlated attribute. Multiple levels of product attribute identification and correlation, as well as multiple levels of re-ranking may be performed in some embodiments. In some embodiments a product filter module may limit the product recommendations to a particular type of product or a particular set of friends. Once the product recommendations have been ranked and filtered, a final recommendation list may be provided.

As described in reference to FIG. 4a, the modules can be implemented, for example, in any suitable programming language and encoded on a machine readable medium that, when executed by a processor (and/or co-processors), carries out the content recommendation function as variously described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose-built logic, or a microcontroller having input/output capability (e.g., inputs for receiving user inputs and outputs for directing other components) and a number of embedded routines for carrying out the system functionality. The functional modules can be implemented in the UI of a computing device, on a remote server, and any combination of server-side/device-side architectures can be implemented to facilitate a content recommendation system in accordance with an embodiment of the present invention.

Methodology

FIG. 5 illustrates a method for providing a user with a product recommendation list, in accordance with an embodiment of the present invention. In one example embodiment, the elements of the following method may be carried out on the various system modules described in reference to FIG. 4c. As can be seen, in this example case, the method starts by determining 501 two or more product sets. The product sets may be determined by a product set generation module of FIG. 4c, in one embodiment, and they may be based on one or more products that the user has purchased, has given a positive rating to, or that have some connection to the user. In one particular example, the user is searching for recommendations similar to a business management book (the source product) and two product sets are determined including: other business management books, and books that were also purchased by those who purchased the source product. The method may continue with analyzing 502 the product sets for product overlap as previously described in connection with FIG. 1 and displayed by the overlapping portions of circles A, B, and C. The product overlap analysis may be performed by the overlap analysis module shown in FIG. 4c, in one embodiment. The method may continue with ranking 503 the products within the product sets based on the product overlap. The method may continue with determining 504 a product attribute. A product attribute may include subject matter, author, artist, genre, brand, category, genre taxonomy, critical reviews, etc. In some embodiments, the product attributes may be received as structured or unstructured meta-data from book publishers (e.g., a 13-digit ISBN, 9-digit SBN, EAN-13 barcode), e-commerce sites, databases, or any other source containing product information or descriptions. In other embodiments, the product attribute may depend on the product overlap analyzed in 502. For example, the products with the most overlap between the initial product sets may be analyzed in order to identify a common attribute. The method may continue with performing 505 product attribute correlation. In one embodiment, the source product is a book by James Patterson and the product attribute correlation may include analyzing several books by James Patterson, identifying characteristics of that author, and correlating this information to similar authors and/or author characteristics. In some embodiments, ranking the products within the product sets can be performed by the ranking module of FIG. 4c, and determining a product attribute and correlating the product attribute may be performed by the product attribute identification and correlation module of FIG. 4c. The method may continue with re-ranking 506 the products within the product sets based on the product attribute. In such an example embodiment, the re-ranking includes analyzing the products within the two or more product sets and re-ranking them within the initial ranking performed at 503 based on those products having the product attribute and those not having the attribute. In some cases, the initial ranking and re-ranking may be performed by the ranking module of FIG. 4c.

The method may continue with determining 507 whether additional re-ranking is needed. In some embodiments, after performing one level of product attribute correlation and re-ranking, the product recommendations may be sufficiently organized to be presented to the user, while in other cases products may be tied in priority level and may require additional re-ranking. If additional re-ranking is desired, a second level of product correlation and re-ranking may be performed by repeating elements 504-506, only determining a different product attribute than the first one determined at 504. Multiple levels of product attribute correlation and re-ranking may be performed as needed. If no additional re-ranking is needed, the method may continue with applying 508 a control filter to the product recommendation ranking. The control filter may be applied through the product filter module of FIG. 4c. In one embodiment, the control filter limits the eventual output result by filtering product recommendations for a particular product or demographic. For example, the control filter might only list a particular product type (e.g., only eBooks), or if the product recommendations are viewable by multiple users the content filter might only display the product recommendations to a particular demographic (e.g., a particular set of friends). In some embodiments, the control filter does not need to be applied last, and may be applied to the product recommendations at an earlier stage within the method (e.g. right after the product sets are determined at 501). The method may continue with providing 509 the final product recommendation list.

Numerous variations and embodiments will be apparent in light of this disclosure. One example embodiment of the present invention provides a system for generating content recommendations including a product set generation module configured to generate two or more product recommendation sets comprising a plurality of product recommendations related to one or more source products. The system also includes an overlap analysis module configured to determine product recommendation overlap between the product recommendation sets. The system also includes a product attribute identification and correlation module configured to determine a product attribute and correlate the product attribute with the product recommendations. The system also includes a ranking module configured to generate an initial ranking of the product recommendations based on the product recommendation overlap and re-rank the product recommendations based on the product attribute. In some cases, the one or more source products include at least one of a service, book, eBook, movie, music file, CD, DVD, electronic device, clothing, magazine, and/or digital magazine. In some cases, three or more product recommendation sets are generated and the overlap analysis module is configured to determine a plurality of overlapping product sets. In some such cases, the product attribute is an attribute of one of the overlapping product sets. In some cases, the product attribute is an attribute of the one or more source products. In some cases, the product attribute is determined from meta-data received from a book publisher, e-commerce site, and/or database containing information or descriptions regarding the one or more source products. In some cases, the product attribute is at least one of: subject matter, author, artist, brand, genre, category, genre taxonomy, and/or critical reviews. In some cases, correlating the product attribute with the product recommendations includes at least one of: determining which product recommendations have the product attribute, and/or determining which product recommendations have a similar product attribute. In some cases, the product attribute identification and correlation module is configured to determine a plurality of product attributes, each product attribute having a ranking priority based on a user's taste profile, and wherein re-ranking the product recommendations is based on the ranking priority of the product attributes. In some such cases, the user's taste profile is determined based on at least one of the user's reading history, shopping cart, wish list, search history, purchase history, content ratings, favorite authors, favorite brands, favorite bands/musicians, favorite games, and/or browser behavior. In some cases, re-ranking the product recommendations results in two or more tied product recommendations; the product attribute identification and correlation module is further configured to determine an additional product attribute and correlate the additional product attribute with the tied product recommendations; and the ranking module is further configured to re-rank the tied product recommendations based on the additional product attribute. In some cases, the system also includes a product filter module configured to filter the product recommendations based on predetermined criteria. In some cases the system is included within a mobile computing device. In some cases, the system is included within a server computing device.

Another example embodiment of the present invention provides a system for generating content recommendations including an electronic computing device, and a server computing device configured to: generate two or more product recommendation sets comprising a plurality of product recommendations related to one or more source products, determine product recommendation overlap between the product recommendation sets, determine a product attribute and correlate the product attribute with the product recommendations, generate an initial ranking of the product recommendations based on the product recommendation overlap and re-rank the product recommendations based on the correlated product attribute, and remotely provide to the electronic computing device a ranked product recommendation list. In some cases, the server computing device is further configured to filter the product recommendation list based on predetermined criteria.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to determine one or more source products; generate two or more related product sets, each set including a plurality of product recommendations; analyze the related product sets for product recommendation overlap; rank the product recommendations based on overlap within the related product sets; determine a product attribute; correlate the product attribute with the product recommendations; and re-rank the product recommendations based on the correlated product attribute. In some cases, the source product includes at least one of a service, book, eBook, movie, music file, CD, DVD, electronic device, clothing, magazine, and/or digital magazine. In some cases, correlating the product attribute with the product recommendations includes at least one of: determining which product recommendations have the product attribute, and/or determining which product recommendations have a similar product attribute. In some cases, the process is further configured to repeat: determining a product attribute; correlating the product attribute with the product recommendations; and re-ranking the product recommendations based on the correlated product attribute until the product recommendations are not tied in ranking priority.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for generating content recommendations comprising:
a product set generation module configured to generate two or more product recommendation sets comprising a plurality of product recommendations related to one or more source products;
an overlap analysis module configured to determine product recommendation overlap between the product recommendation sets;
a product attribute identification and correlation module configured to determine a product attribute and correlate the product attribute with the product recommendations; and
a ranking module configured to generate an initial ranking of the product recommendations based on the product recommendation overlap and re-rank the product recommendations based on the product attribute.

2. The system of claim 1 wherein the one or more source products comprises at least one of a service, book, eBook, movie, music file, CD, DVD, electronic device, clothing, magazine, and/or digital magazine.

3. The system of claim 1 wherein three or more product recommendation sets are generated and wherein the overlap analysis module is configured to determine a plurality of overlapping product sets.

4. The system of claim 3 wherein the product attribute is an attribute of one of the overlapping product sets.

5. The system of claim 1 wherein the product attribute is an attribute of the one or more source products.

6. The system of claim 1 wherein the product attribute is determined from meta-data received from a book publisher, e-commerce site, and/or database containing information or descriptions regarding the one or more source products.

7. The system of claim 1 wherein the product attribute is at least one of: subject matter, author, artist, brand, genre, category, genre taxonomy, and/or critical reviews.

8. The system of claim 1 wherein correlating the product attribute with the product recommendations comprises at least one of: determining which product recommendations have the product attribute, and/or determining which product recommendations have a similar product attribute.

9. The system of claim 1 wherein the product attribute identification and correlation module is configured to determine a plurality of product attributes, each product attribute having a ranking priority based on a user's taste profile, and wherein re-ranking the product recommendations is based on the ranking priority of the product attributes.

10. The system of claim 9 wherein the user's taste profile is determined based on at least one of the user's reading history, shopping cart, wish list, search history, purchase history, content ratings, favorite authors, favorite brands, favorite bands/musicians, favorite games, and/or browser behavior.

11. The system of claim 1 wherein: re-ranking the product recommendations results in two or more tied product recommendations; the product attribute identification and correlation module is further configured to determine an additional product attribute and correlate the additional product attribute with the tied product recommendations; and the ranking module is further configured to re-rank the tied product recommendations based on the additional product attribute.

12. The system of claim 1 further comprising a product filter module configured to filter the product recommendations based on predetermined criteria.

13. A mobile computing device comprising the system of claim 1.

14. A server computing device comprising the system of claim 1.

15. A system for generating content recommendations comprising:
an electronic computing device; and
a server computing device configured to generate two or more product recommendation sets comprising a plurality of product recommendations related to one or more source products, determine product recommendation overlap between the product recommendation sets, determine a product attribute and correlate the product attribute with the product recommendations, generate an initial ranking of the product recommendations based on the product recommendation overlap and re-rank the product recommendations based on the correlated product attribute, and remotely provide to the electronic computing device a ranked product recommendation list.

16. The system of claim 15 wherein the server computing device is further configured to filter the product recommendation list based on predetermined criteria.

17. A computer program product comprising a plurality of instructions non-transiently encoded thereon to facilitate operation of an electronic device according to the following process:
determine one or more source products;
generate two or more related product sets, each set comprising a plurality of product recommendations;
analyze the related product sets for product recommendation overlap;
rank the product recommendations based on overlap within the related product sets;
determine a product attribute;
correlate the product attribute with the product recommendations; and
re-rank the product recommendations based on the correlated product attribute.

18. The computer program product of claim 17 wherein the source product comprises at least one of a service, book, eBook, movie, music file, CD, DVD, electronic device, clothing, magazine, and/or digital magazine.

19. The computer program product of claim 17 wherein correlating the product attribute with the product recommendations comprises at least one of: determining which product recommendations have the product attribute, and/or determining which product recommendations have a similar product attribute.

20. The computer program product of claim 17 wherein the process is further configured to repeat: determining a product attribute; correlating the product attribute with the product recommendations; and re-ranking the product recommendations based on the correlated product attribute until the product recommendations are not tied in ranking priority.
